(19) United States
(12) Patent Application Publication
(10) Pub. No.: US 2002/0018762 A1
(43) Pub. Date: Feb. 14, 2002

(54) Utilizing camptotheca products for termite control

(75) Inventor: Shiyou Li, Nacogdoches, TX (US)

Correspondence Address: ALAN R. Thiele, JENKENS & GILCHRIST, P.C., 1445 Ross Avenue, Dallas, TX, 75202-2799, US

(73) Assignee: Stephen F. Austin State University

(21) Appl. No.: 09/896,298

(22) Filed: Jun. 29, 2001

Related U.S. Application Data
(60) Provisional application No. 60/214,958, filed on Jun. 29, 2000.

(51) Int. Cl. A01N 43/42; A01N 25/00

(52) U.S. Cl. 424/84; 424/405; 514/283

(57) ABSTRACT

This invention relates to insect control with Camptotheca products, particularly, termiticides, baits, preservatives, and termite-resistant products. Natural or synthetic Camptothecin and/or one of its natural or synthetic analogs is applied to deter and/or eliminate termites, while flavonoids are applied to attract termites. CPTs and/or CPTs-containing plant matter is processed with cellulose products to produce termite-resistant products and structures.

This patent application claims the benefit under Title 35, United States Code, § 119(e) of U.S. Provisional Patent Application Serial Number 60/214,958, filed Jun. 29, 2000.

### FIELD

The present invention relates to control of termites; more specifically, the present invention describes a system and method for using Camptotheca products for termite control, particularly, termiticides, baits, preservatives and termite-resistant cellulose products.

### BACKGROUND OF THE INVENTION

### Termite Problems in the U.S.A.

Termites are known to occur in virtually every state in the United States, all U.S. territories, and throughout the world. Termites are among the most economically threatening insects in the world (Agricultural Research Service 2000). While ecologically important in nutrient recycling, they are best known as structural and plant pests that compete with economic interests.

Termites often infest buildings and cause damage to lumber, wood panels, flooring, sheet rock, wallpapers, plastics, paper products, and fabric made of plant fibers. They attack flooring, carpeting, art work, books, clothing, and furniture. They are also destructive to cultivated plants and crops, where they burrow into stems, tunnel out stalks and roots, and girdle the bark of trees. The most serious damage involves the loss of structural strength. They cause more than $2 billion in damage each year in America, more property damage than that caused by fire and wind-storm combined (Su and Scheffrahn 1990; Gold et al. 1999; Kamble 2000).

There about 275 genera of termites (Order Isoptera) in the world: only 13 have cosmopolitan distributions. The insects that attack and destroy wooden structures are classified into three major categories: drywood, dampwood, and subterranean termites. Drywood termites (Incisitermes) do not require a source of water or any contact with the soil. They are found in the southern tier of the United States, from North Carolina throughout the Gulf Coast states, and into the coastal areas of California. Drywood termites may infest any wooden products, especially dry, undecayed wood, including structural lumber as well as dead limbs of trees, utility poles, posts, and lumber in storage.

Dampwood (Zootermopsis) termites do not require contact with the soil but wood with a high degree of moisture is needed. They are usually associated with decaying wood. They are found in logs, stumps, old standing dead trees, or poorly constructed buildings, particularly in the Pacific Northwest, Nevada, and Florida. Subterranean termites (Rhinotermitidae) are the most common and do the most damage of all termite species. They live in large underground colonies of several thousand to several million individuals. They consume cellulose maters in the surrounding environment.

There are two common and destructive genera of subterranean termites: Reticultitermes and Coptotermes. Reticultitermes is the principle termite pest in the Northern Hemisphere: Canada, USA, Mexico, Europe, Southern Russia, Middle East, Northern Africa, India, Korea, Japan, China (mainland and Taiwan). However, Formosan subterranean termite (Coptotermes formosanus) is the most destructive of all termite species, accounting for 95% of all termite damage (Kamble 2000). It is native to China and Japan. It is suspected that the Formosan subterranean termite was introduced into the United States through ships sometime after World War II (Louisiana State University Agricultural Center 2000). Without natural enemies, this exotic pest has spread over California, Texas, Louisiana, Mississippi, Alabama, Georgia, Tennessee, South Carolina, North Carolina, and Florida in 50 years.

A Formosan termite colony can have over 10 million individuals, as compared to 300,000 individuals for native termite colonies (Louisiana State University Agricultural Center 2000). They are aggressive foragers that will persistently test chemical barriers, seeking ways in which they can penetrate treated soil. Besides attacking buildings, Formosan termites also destroy living trees. Their nests are difficult to destroy, once established. To date, a long-term, efficient, and environmentally friendly chemical control method for Formosan termite is not available. Formosan termites are the primary concern today (Hunter 2000). In fact, the USDA launched a national termite-fighting campaign in 1998.

### Current Status of Termite Control

Conventional methods to control termites employ a chemical barrier zone that either directly or indirectly repels the termites. However, while effective in repelling termites, chemical barriers do not adversely affect the termite colony. Due to the ineffective termite control methods, vast populations of termites continue to represent a significant threat to living trees, wood products and wooden structures (Reid et al. 2000). Conventional approaches for excluding termites are failing (King 1998). Defending a building using chemical repellents around its perimeter does not decrease termite populations or activity in the surrounding area (Suszkiw 1999). Many termiticides (i.e., organochlorine) remain in the soil for a long time and do not break down into innocuous residues, causing an environmental hazard.

Use of many of these insecticides has been severely limited or prohibited because these chemicals present great danger to humans and animals (U.S. Pat. No. 5,564,222). For example, chlordane, the last effective organochlorine used as a termiticide, was banned in 1988 due to human health and safety concerns (King 1998). Chemicals available today do not provide the same long-term control as did organochlorine compounds (King 1998). Because chemical barriers are unreliable, costly, may not give long-term protection, and may damage the environment, alternatives have been developed over the past few years.

A substitute for a soil barrier is pressure-treatment of wooden structures with chemicals to protect termite damage. Some wood preservatives have been developed to provide an envelope of protection for the wood component against wood-destroying organisms. Commonly used compositions for the pressure process include CCA (containing copper, chrome, and arsenic), CFK (containing copper, chrome, and fluorine), and CFK-Z (containing copper, chrome, zinc, and fluorine).

Many of the materials used for such wood treatments are hazardous. Pressure-treated wood, often in direct soil contact, may contain arsenic, heavy metals, or other toxic elements that can escape into the environment or leach into contacting fluids or soil, leaving potentially toxic residues (U.S. Pat. No. 5,564,222). For example, CCA was banned in Europe and Japan years ago. Recently, less toxic organophosphorus compounds (phoxim, chlorpyrifos, and fenitrothion), carbamate compounds (bassa and propoxur), and pyrethroid compounds (permethrin, tralomethrin, befenthrin, cyfluthrin, and deltamethrin) have been used in wood treatment. However, these compounds are less effective in termite control. Thus, an alternative effective preservative with less environmental contamination is imperative to the wood industry.

Only water-insoluble preservatives can be successfully used to treat oriented strandboard (OSB) due to problems associated with thickness and swelling of the panels and possible leaching of exposed panels on a job site. Currently, there is little treated OSB production in the United States (Shupe and Dunn 2000). Louisiana-Pacific plans to produce treated OSB named SmartGuard™ in its plant in Silsbee, Tex. in 2000. The Formosan termite situation in Louisiana may eventually have implications for the engineered wood industry throughout North America (Shupe and Dunn 2000).

Formosan termites infest over a dozen states in the United States and cannot be controlled by conventional methods. In 1998, the U.S.D.A. initiated a national campaign called “Operation Full Stop” to reign in the Formosan termite and minimize its damage through the use of environmentally sound management practices. Recently, baits have become an important approach to monitoring termites. The development of toxic baits has become a key strategy of the “Operation Full Stop” campaign.

Unlike other methods, effective baits can eliminate termite colonies. The termite baiting strategy includes two steps: (1) to attract a large number of termites by an attractant; and (2) to eliminate the termite colony by exposure to a slowing-acting non-deterrent toxicant. Theoretically, many wood or cellulose products can be used to attract termites. It was found that amino acids, agar, sawdust, rotten wood, cork, and toilet papers are better attractants (Quarles 1995). It can take several months to a year or longer for termites to find bait stations. However, the toxicant cannot be introduced into the colony until the termites find the bait stations. Thus, a more attractive material or compound is desirable. Boric acid and its salts, diflubenzuron, fenoxycarb, hexaflumuron, hydramethylnon, mirex, silafluofen, and sulfluramid have been used as bait toxicants over the last ten years (Quarles 1995).

There are two general types of food baiting: perimeter baiting and interceptive baiting. If the whereabouts of the termites are unknown, perimeter baiting is used: wood stakes, bait blocks, and plastic monitoring stations are set around the perimeter of a structure. Once termites have been located, interceptive baiting can be used (e.g., pipe-bait container, bait-box conduit). Some current bait products in the markets include: Sentricon™ (Dow Agro Sciences), FirstLine GT™ (FMC Corporation), Terminate™, Subterfuge™ (American Cyanamid), BioBlast™ (EcoScience Corporation), and SubStation Bait Delivery System™ (American Cyanamid). Baits have some advantages over barriers in that only small amounts of toxicants are used and the toxicant is fully contained in bait stations which are inaccessible to human and animals. Baits may provide a long-term termite control approach. However, baits have some limitations, e.g., less effectiveness during cold seasons, and working slowly to eliminate a colony (several months or more). In addition, current commercial bait toxicants are not as effective in field applications as one would expect from their claims.

Besides developing synthetic compounds as termiticides, some studies have focused on natural products. A few American and Asian tree species have been found to have natural resistance to termites. For example, Alaska cedar (Chamaecyparis nootkatensis), redwood (Sequoia sempervirens), and teak (Tectona grandis) compare favorably in termite resistance to preservative-treated wood (Grace and Yamamato 1994). From fungi coexisting with subterranean termites, phagostimulatory and phagodeterrent compositions were extracted (U.S. Pat. No. 6,203,811). The results led to the identification of natural active compounds against termites from these species. Usually, the natural products cause less environmental contamination than synthetic termiticides. However, the successful development of an effective termiticide from the natural products is still lacking.

### Utilization of Camptotheca Products

Camptotheca (happytrees) are native to China—also where Formosan termites originate. Camptothecin (CPT) and its analogs from these trees have shown promising anti-cancer activity. In the present invention, CPTs refer to natural and synthetic Camptothecin (CPT) and its natural and synthetic analogs. Since the identification of CPT in 1966 (Wall et al. 1966), at least 13 different naturally occurring minor CPTs have been identified from wood, bark, and fruits of C. acuminata. CPTs are successful in treating many types of cancer (Li and Adair 1994). Based on these natural CPTs, many semi-synthetic CPT analogs have been developed in the last 30 years, and some have developed promising anti-cancer drugs. For example, Topotecan (TPT, Hycamtin®) and Irinotecan (CPT-11, Camptosar®) were approved by the US Food and Drug Administration (FDA) for the treatment of advanced ovarian cancer, small cell lung cancer, and colon cancer. 9-Nitrocamptothecin (9-NC, Rubitecan®), 9-Aminocamptothecin (9-AC), and several other CPT analogs are in clinical trials and may receive approval as anti-cancer drugs in the near future.

Camptotheca spp. are fast growing trees. The maximum height growth in the early seedling stage can be up to about 9 ft per year under favorable conditions. The mature tree can reach 130-150 ft in height and 2.6-4.0 ft in diameter. Because of its rapid growth and early maturation characteristics, Camptotheca acuminata is one of 84 major national reforestation species in China. The wood is soft, light, odorless, easy to dry, easy to process, pest resistant, smooth grained and even-textured, with high flexibility and low strength. Primary wood products are rulers, packaging materials, furniture, mine timbers, pulpwood, and fuel wood.

In addition, CPTs isolated from Camptotheca are plant growth regulators. In Yunnan and Hunan, native Bai and Han people have used the leaves of Camptotheca as green fertilizer for rice seedlings since 1950 (Li et al. 2000). According to local farmers, rice production is greatly increased by this application. It is also claimed that use of the leaves controls insect pests and rice disease. Application of the leaves as green manure challenges current theory that the Camptotheca is allelopathic and limits the growth of many crops (Buta and Worley 1976; Buta and Spaulding 1986; Tao and Buta 1986; Buta and Kalinski 1988).

More importantly, the wood of Camptotheca acuminata has been found to resist termites. In China, tree species have been classified into four levels of resistance to Formosan termite, with the first class having the greatest termite resistance and the fourth class having the least termite resistance. Camptotheca acuminata is known as a second class termite-resistant species (Cheng 1985). However, a detailed study is not available, and the resistance mechanism has not been identified.

CPTs are known as potent chemosterilants for flies and caterpillars. DeMilo and Borkovec (1974) discovered that fecundity and hatchability of the house fly (Musca domestica) are remarkably reduced after exposure to CPTs. In China, extracts from Camptotheca are also used to control Masson pine caterpillar (Dendrolimus punctatus), the most damaging forest pest in China (Hunan Institute of Forestry 1978). The mortality of the insect larvae, pupae, and adults increased after treatment with CPT, and the hatchability of eggs decreased after treatment with 0.05% CPT. Some authors believe that raw extractions of Camptotheca and five other plant species are useful as pesticides, but no data on specific pests or experimental methods are disclosed. (Chinese Pat. No. CN1056622A).

Presently, Camptotheca (Nyssaceae) consists of C. acuminata Decaisne, C. acuminata var. tenuifolia Fang et Song, C. acuminata var. rotundifolia Yang et Duan, C. yunnanesis Dode, C. lowreyana Li, and C. lowreyana Li ‘Katie’. Other known CPTs-containing plants are Ervatamia (Apocynaceae), Nathapodytes (Mappia) (Olacaceae), Ophiorrhiza (Rubiaceae), Merrilliodendron (Icacinaceae), Mostuea (Loganiaceae), and Pyrenacantha (Icacinaceae).

### SUMMARY OF THE INVENTION

The present invention provides environmentally-friendly natural termite stimulant and deterrent compositions extracted from Camptotheca trees and other CPTs-containing plants. Camptothecin (CPT) and its analogs, the alkaloids originated from the plants, are used as active ingredients in termiticides, barriers, baits, and preservatives, deterring and eliminating termites, particularly subterranean species. Pure or raw water-insoluble CPT and its analogs, the alkaloids from the plants, as well as synthesized alkaloids, may be useful in termite control strategies as barriers at higher concentrations (>50 ppm), by deterring the termites from colonizing or feeding on particular substrates and structures. Pure or raw CPT and its analogs, as well as synthesized alkaloids, may be useful as toxicants in termiticides and baits, particularly at lower concentrations.

Flavonoids from plants are used as potent attractants in bait systems. Natural plant matters (e.g., leaves, stems, wood, bark, fruits, roots) of Camptotheca or related plants containing both CPTs and flavonoids are used as baiting materials to attract and eliminate termites. In another aspect of the invention, natural plant matters (e.g., leaves, stems, wood, bark, fruits, roots) of Camptotheca or related plants containing both CPTs and flavonoids can be developed as baiting materials to attract and eliminate termites. The flavonoids extracted from Camptotheca or related plants, as well as synthesized flavonoids, may be useful as potent attractants in the termite bait systems.

CPTs and treated CPTs-containing plant matters are used to produce termite-resistant cellulose products, particularly wood products such as particleboard. CPTs as preservatives are useful in treating cellulose bodies such as wood, paper, or laminated paper or in developing such products as a component to protect the products from termite attack. For example, pure or raw CPTs are useful as wood preservatives in commercial lumbers and other wood products (by either spray, pressure-treatment or other methods). Water-treated CPTs-containing plant matters of Camptotheca or other plants are useful in direct application of termite-resistant cellulose products. For example, the water-treated wood materials of Camptotheca trees may be key components in termite-resistant wood products such as particleboards. CPTs and flavonoids may be in liquid, aerosol, or dust formulations according to the present invention.

### BRIEF DESCRIPTION OF THE DRAWINGS

A better understanding of the system and method of the present invention may be had by reference to the drawing figures wherein:

FIG. 1 illustrates the applications of natural products of Camptotheca in pesticides according to the present invention;

FIG. 2 illustrates the methods for pest-resistant product development, including termite-resistant particleboard;

FIG. 3 illustrates the effects of water treatment on the contents of flavonoids and CPTs; and

FIG. 4 illustrates the effect of the particleboard process on CPT content.

### DETAILED DESCRIPTION OF THE INVENTION

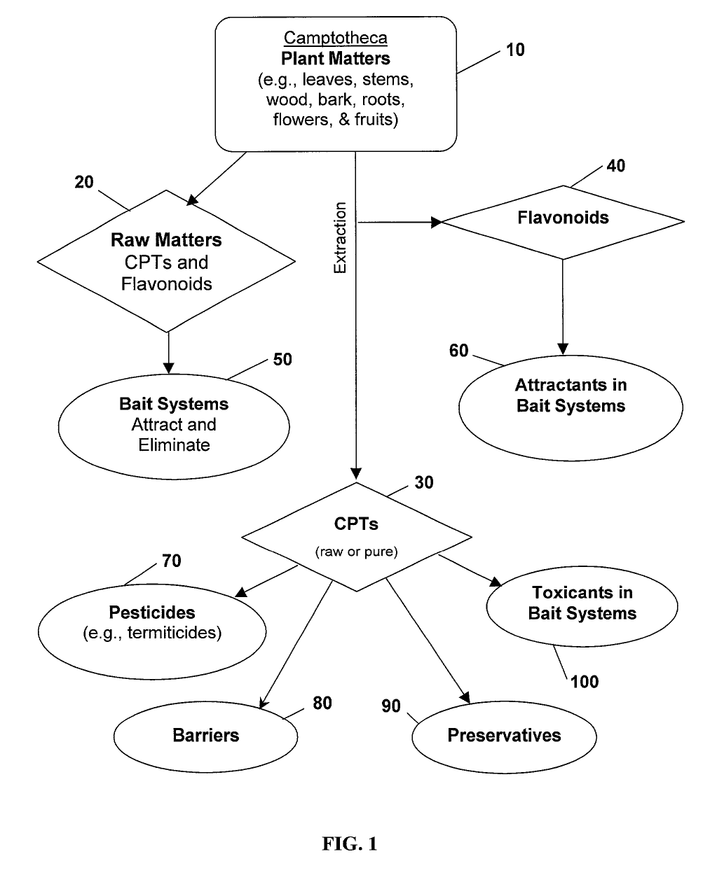

The present invention describes the use of CPTs, CPTs-containing wood matters, and flavonoids in the development of termite-control and termite-resistant products as shown in FIG. 1.

### CPTs as Termiticides, Barriers, Baits, and Preservatives

The present invention reveals that water-insoluble pure (>95%) and raw (<95%) CPT and its analogs, (in particular, CPT and 10-hydroxycamptothecin (OHCPT)), as insect growth regulators, are potent agents to eliminate termites. As described in Examples 1 and 2, southern yellow pine stakes treated with either CPT extraction from young leaves or purified CPT (>95%) were damage free from termites within a week (and all termites dead) while during the same time period the untreated control wood (termite mortality: 0%) and wood treated with flavonoids was significantly damaged by termites (termite mortality: 6.7%). Foraging termites with CPTs (3.8 ppm to 8.8 ppm) will completely kill the termites within a week. Therefore, CPTs are useful in the application of termiticides.

Cellulose products, including wood or wood based products, which were treated with these alkaloids as preservatives were damage-free from termites, as shown in Example 3. These cellulose products may be treated with pure or raw CPTs (>50 ppm) by spray, pressure-treatment, or other methods to prevent termite attack.

The potent termite-repellency of CPTs makes them useful in deterrent barriers, particularly at higher concentrations (>300 ppm). CPTs may be useful as bait toxicants to eliminate a termite colony within four weeks as shown in Example 4.

The termite-repellency of CPTs at lower concentrations (0.1 ppm-100 ppm) is reduced by the attractiveness of flavonoids. Actually, even with higher CPT concentrations, such as in Camptotheca plants (CPT up to 1,200 ppm), the repellent effect of CPTs is still significantly reduced by flavonoids. Therefore, CPTs at higher concentrations (e.g., 1,200 ppm) may still be used as active ingredients (toxicants) of bait systems (e.g., wood stakes, bait blocks, and plastic stations) with the presence of flavonoids as attractants.

In all above applications, CPTs can be used in liquid, aerosol, or dust formulations. The mechanism of CPTs as insect growth regulators is under investigation.

The obvious advantage of the use of these natural products for termite control is the environmental friendliness of the method. The preferred CPT concentrations of the present invention would not produce environmental problems because they are within the range of natural CPT concentrations of some tissues of Camptotheca (e.g., 300-1,200 ppm in young leaves, 100-500 ppm in fruits). CPTs are odorless, and unlikely to produce allergic problems in humans and animals. Because many CPTs are insoluble in water, very little CPTs should leach into the soil.

### Flavonoids Useful as Attractive Agents in Termite Baits or Detectors

According to the present invention, flavonoids, commonly existing in many parts of Camptotheca trees and other plants, attract termites quickly and make the wood samples treated with these compounds more susceptible to termites, as shown in Examples 1-4. Southern yellow pine lumber treated with CPT extraction from young leaves or purified CPT (>95%) were damage-free from termites within 3 months in the field, while the untreated control wood and the wood treated with flavonoids was significantly damaged by termites within the same time period.

Flavonoids, as feeding stimulants, can be used as potent and quick attractants in the development of termite baits and detectors, e.g., wood stakes, bait blocks, and plastic monitoring stations, in liquid, aerosol, or dust formulations. A cellulose product may be treated with a flavonoid solution, e.g., spraying, soaking, pressure treating, or injection. Because the termites quickly find and readily feed on the wood treated with flavonoids, these termite baits and detectors effectively trap the termites and subsequently poison them.

Flavonoids can be isolated from Camptotheca tissues easily at very low cost. The discovery of flavonoids' effects on termites explain why the lumber of Camptotheca is not “very resistant” (according to the hierarchical resistance scale) to termites as observed in the field. Both CPTs and flavonoids naturally occur in Camptotheca trees. Our recent analysis showed that CPT content in 5-year old stem wood is 0.005-0.008% (based on the fresh weight), while CPT contents in some young tissues are up to 0.12% on the basis of fresh weight. The flavonoid content is much higher than CPTs especially in bark and leaves. The positive resistance of the trees (CPTs expel and eliminate termites) may be counteracted by the negative effect of flavonoids which attract termites. This explains why Camptotheca trees are not more resistant to termites under natural conditions.

### Development of Termite Bait and Termite-resistant Cellulose Products

As shown in FIG. 1, the present invention provides that CPTs are termite bait toxicants and flavonoids are termite attractants. Natural matters (e.g., leaves, stems, wood, bark, fruits, roots) of Camptotheca 10 and related plants can be directly applied as raw matters 20 in bait systems 50 to attract and eliminate termites. This is due to the fact that the plant matters contain sufficient CPTs (10-1,200 ppm) to repel the insects, and the CPTs repellency is significantly reduced by the attractiveness of the flavonoids 40. These flavonoids 40 are effective as attractants in bait systems 60.

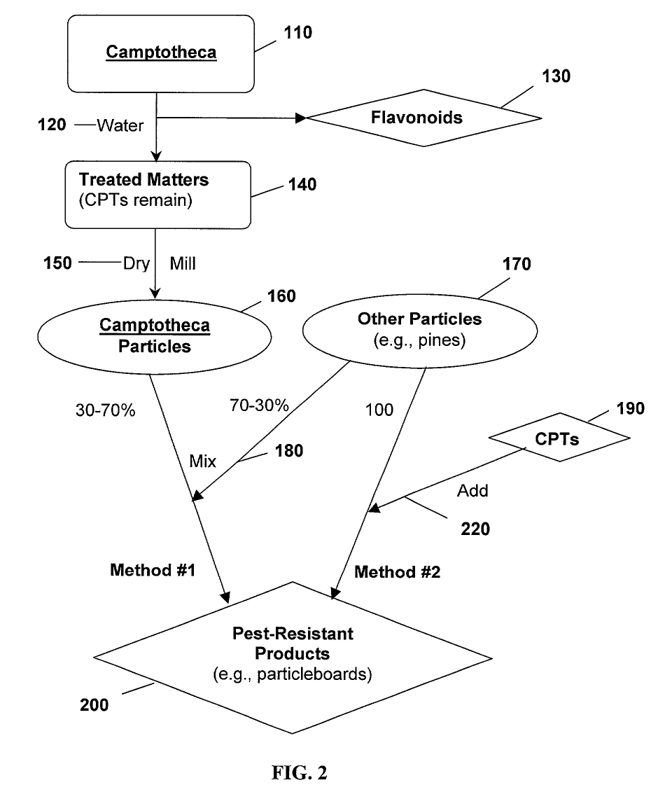

Without termite-attracting flavonoids, natural CPTs-containing plant matters are useful in the development of termite-resistant cellulose products. As shown in FIG. 2, the Camptotheca plant matters 110 are soaked in water 120 to remove the flavonoids 130. The treated matters 140 which remain, retain the CPT. These matters are processed 150 into Camptotheca particles 160. These particles 160, are combined with other particles, e.g., pine, 170 in step 180 to create pest resistant products 200, e.g., particle boards. Alternatively, CPTs 190 may be added directly to the other particles 170 as shown in step 210 to create pest resistant products 200. A water soak can easily extract the flavonoids from plant matters without significant effects on the contents of water-insoluble CPTs, as shown in Example 5. It takes less than a week to extract flavonoids out of the smaller wood particles. As shown in FIG. 1, the raw or pure CPTs 30 are useful as pesticides 70, barriers 80, preservatives 90, and bait system toxicants 100.

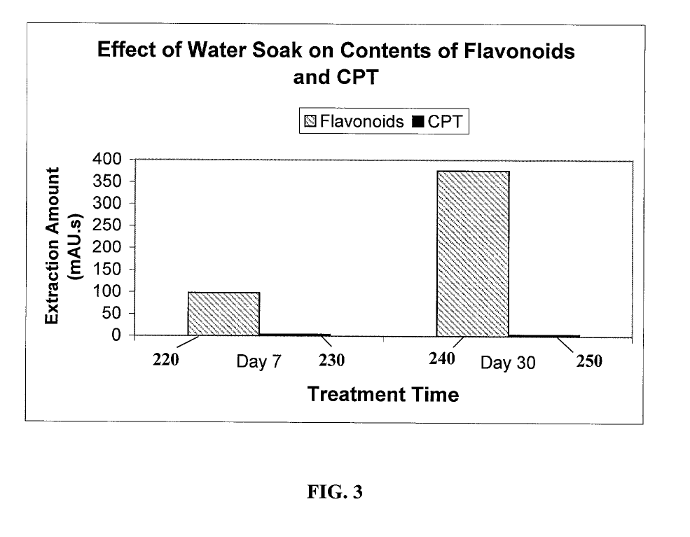

For example, the Camptotheca wood containing CPTs (CPT concentrations: 30-100 ppm) after extraction of flavonoids may be used in preparation of termite-resistant wood products such as composition boards, particleboards, and fiberboards. FIG. 3 illustrates the effect of a water soak on the content of flavonoids and CPT over time. While the flavonoids 220 at day 7, show a significant amount of extraction, the CPT 230 is not extracted. At day 30, the amount of flavonoids extracted 240, has greatly increased, whereas the CPT 250 remains water insoluble.

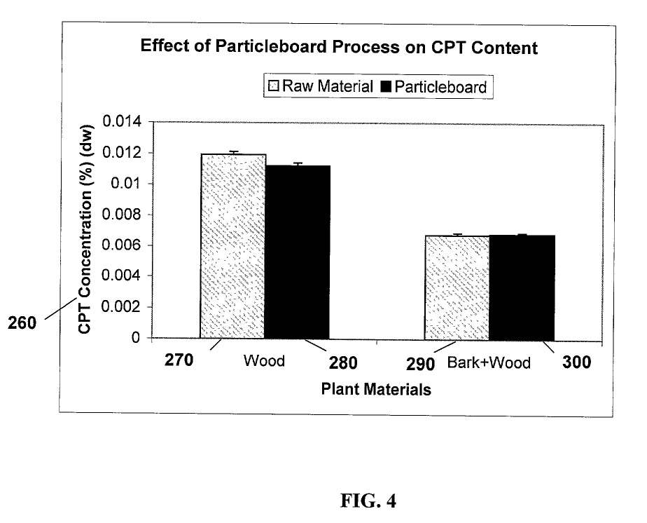

Particleboard is an engineered wood product used as core material in the construction of home and office furniture, shelving and kitchen cabinets, as well as commercial and institutional fixtures. The major source for the manufacture of particleboard is southern yellow pine. Termite-resistant particleboard is not available. The present invention provides a method of preparing termite-resistant particleboards by including 30-70% Camptotheca wood in combination with currently-existing particleboard materials, e.g., pine, in a process as shown in Example 6. The particleboard process has no significant effect on CPTs content in the particleboards. As shown in FIG. 4, the CPT content 260 in the raw material from wood 270 and the particleboard from wood 280 remain virtually the same. Similarly, the CPT content 260 in the raw material from bark and wood 290 and the particleboard from bark and wood 300 remained the same after the particleboard process. Our CPT analysis revealed that wood of all Camptotheca species, varieties, and cultivars contains enough CPT content to be developed as termite-resistant products.

### EXAMPLES

The invention is further illustrated by the following representative examples, but the invention is not limited by the details set forth in these examples.

### Example 1

### Objective

To investigate the active compounds of Camptotheca against subterranean termites in laboratory tests.

### Method

60 active subterranean termites (Reticultitermes virginicus) were grown in 9 cm Petri dishes in dark with 15 termites (10 soldiers and 5 workers) in each of four dishes. In each dish, a filter paper is placed on the bottom of the dish to retain moisture along with a piece of treated southern yellow pine wood (decayed, 3×3×7 cm). The wood was treated with one of the following natural products isolated from Camptotheca acuminata or water (as control) for 30 minutes and then dried: (1) pure CPT (>97%) (camptothecin, 3.8 mg/l=3.8 ppm, with water as the solvent); (2) raw extraction of CPTs from young tissues (alkaloids: 8.75 mg/l=8.75 ppm, with 95% ethanol as the solvent); (3) flavonoids (13.9 mg/l=13.9 ppm with water as the solvent); and (4) water (control). The termites and wood condition were checked and recorded every hour for the first 12 hours and every 8 hrs thereafter. The observation period was 4 weeks (May 17 to Jun. 14, 2000).

### Results

The results of the treatments are shown in Table 1. For the control treatment, all 15 termites grew well and were active during the observation period. Some termites accessed the wood within 5 hours. The wood sample was obviously damaged by termites within 16 hours. Termite mortality was 6.7% within 4 weeks.

With the CPT treatment, the termites became inactive after 6 hours. Six of the total 15 termites died within 36 hours. Termite mortality was 100% within 4 days with no obvious damage to the wood sample.

With the raw CPT treatment, the termites did not return to the wood sample after the initial contact and 11 were dead within 2 hours and the rest were dead within 24 hours. Termite mortality was 100% within 1 day. No wood damage was found during the entire observation period.

With the flavonoid treatment, in contrast, all of the termites assembled on the wood at the onset of the experiment. The wood damage was obvious after 16 hours. All termites but one was very active and healthy during the observation period. Only one termite died on the third day, and five died in the 4th week. Termite mortality was 40% within 4 weeks.

TABLE 1
Termite-toxic effect of pure and raw CPTs and attractiveness of
flavonoids in laboratory tests: Experiment I (see Example 1).

| | Mortality | |
|---|---|---|
| Treatment | within 1 week | Mortality within 4 weeks |
| Control | 0 | 6.7% |
| CPT | 100% | 100% |
| Raw CPTs extraction | 100% | 100% |
| from young leaves | | |
| Camptotheca flavonoids | 6.7% | 40% |

### Example 2

### Objective

Replication of Example 1 with large termite populations: To further investigate the termite-toxic effects of pure and raw CPTs and the termite-attractiveness of flavonoids in laboratory tests.

### Method

180 active subterranean termites, were grown in 9 cm Petri dishes in the dark with 30 termites in each of six dishes. In each dish, a filter paper is on the bottom to retain moisture along with a piece of treated southern yellow pine wood (relatively fresh, 3×3×7 cm). The wood was treated with one of the following natural products isolated from Camptotheca acuminata or water (as control) for 30 minutes and then dried: (1) pure CPT (>97%) (3.8 mg/l=3.8 ppm, with water as the solvent); (2) OHCPT (10-hydroxycamptothecin: 3.8 mg/l=3.8 ppm, with water as the solvent); (3) raw extraction of CPTs from young tissues (alkaloids: 8.75 mg/l=8.75 ppm, with 95% ethanol as the solvent); (4) flavonoids (13.9 mg/l=13.9 ppm with water as the solvent); (5) ethanol (95%); and (6) water (control). The termites and wood condition were checked and recorded every hour for the first 12 hours and every 8 hrs thereafter. The observation period was 4 weeks (May 20 to Jun. 17, 2000).

### Results

The results of the treatments are shown in Table 2. For the control treatment, all 30 termites grew well and were active during the observation period. Some termites accessed the wood sample within five hours. The wood damage was obvious after 16 hours. At the end of 4 weeks, all of the termites were alive.

With the CPT treatment, most termites avoided getting close to the wood after the initial contract and all became inactive after 10 hours. 12 termites died within 24 hours and the surviving termites were unhealthy. All 30 termites were dead within 5 days. The wood sample had no obvious damage.

The OHCPT treatment was similar to the CPT treatment. 16 termites were dead within 24 hours and the rest were not active. Mortality was 100% within 6 days. The wood sample had no obvious damage.

For the treatment with raw CPTs extraction from young leaves, termites never approached the wood sample after the initial contact. 20 died within 6 hours and another 4 died within 24 hours. The survivors were unhealthy. Termite mortality was 100% within 5 days. No obvious wood damage was observed.

With the flavonoid treatment, in contrast, all of the termites assembled on the wood within the first hour. All of the termites were very active and healthy during the observation period, with the exception of 4 that died within 7 days. Termite mortality was 13.3% within 4 weeks. Wood damage was observed.

With both the ethanol treatment and the intact-tissue extraction, termite mortality was 100% within 4 hours. No wood damage was observed.

TABLE 2
Termite-toxic effect of pure and raw CPTs and attractiveness of
flavonoids in laboratory tests: Experiment II (see Example 2).

| | Mortality | |
|---|---|---|
| Treatment | within 1 week | Mortality within 4 weeks |
| Control | 0 | 0 |
| CPT | 100% | 100% |
| OHCPT | 100% | 100% |
| Raw CPTs extraction from | 100% | 100% |
| intact young clipping | | |
| Flavonoids | 13.3% | 13.3% |
| Ethanol | 100% | 100% |

### Example 3

### Objective

To investigate the termite-resistance (efficacy and persistence) and termite-repellency of the wood products treated with pure CPT or raw CPTs and the termite-attractiveness of the wood products treated with flavonoids in the field.

### Method

There were 4 treatments including 3 pieces of sound southern yellow pine boards (30×9×4 cm) each. The wood was treated with either a natural product isolated from Camptotheca acuminata or water as a control. The wood was sprayed twice and then dried with one of the following: (1) pure CPT (>97%) (380 mg/l=380 ppm, with water as the solvent); (2) raw extraction of CPTs from young tissues (alkaloids: 8.75 mg/l =8.75 ppm, with 95% ethanol as the solvent); (3) flavonoids (13.9 mg/l=13.9 ppm with water as the solvent); and (4) water (control). The boards were randomly placed on the ground where no termites were observed. The wood condition and termite activity were checked and recorded every week beginning May 20, 2000.

### Results

Three months later, there was no termite damage (including drywood termite, Incistermes snyderi damage) in any of the CPT-treated lumber (380 ppm), 0-0.2% damage (based on weight) in wood treated with raw extraction of CPTs from young tissues (8.75 ppm), 1.2-3.1% damage in the untreated control wood, and 1.7-4.6% damage in flavonoid-treated wood.

### Example 4

### Objective

To investigate the baiting effects of CPTs and flavonoids on a termite colony.

### Method

Each of 18 partially-decomposed southern yellow pine stakes (10×4×2 cm) were treated with one of the following natural products isolated from Camptotheca acuminata or water (as a control) for 30 minutes and then dried: (1) CPT (>97%) (38 mg/l =38 ppm, with water as the solvent); (2) OHCPT (3.8 mg/l=3.8 ppm, with water as the solvent), (3) raw extraction of CPTs from young leaves (alkaloids: 8.75 mg/l=8.75 ppm, with 95% ethanol as the solvent); (4) raw CPTs extraction from intact-young clipping (alkaloids: 8.75 mg/l=8.75 ppm, with 95% ethanol as the solvent); (5) flavonoids (13.9 mg/l=13.9 ppm with water as the solvent); and (6) water (control). The wood was randomly placed on the ground where a termite colony was found under a log with a size of 2 ft×2.5 ft, and then the infested log was replaced. The termites were still active on both the log and ground when the wood was replaced. The observation period was about one year (Jun. 13, 2000 to May 31, 2001). The wood condition and termite activity was checked and recorded every week.

### Results

The termites were still active over the site during the first day. Termites were concentrated on the stakes treated with flavonoids by the second day. By the end of the first week, termites disappeared from the log and ground except where the wood was treated with flavonoids. Four weeks later, no termites were found on the site and within one foot of the soil. Subsequently, termites were never found on the experimental site during the one year observation period. The reason for the quick disappearance of termites from most stakes, including the control, is the repellency of CPTs, while the stakes treated with flavonoids were infested because of the strong attractiveness of flavonoids to termites. The final termite disappearance from the site is likely due to the deterring and killing effects of CPTs.

### Example 5

### Objective

To develop termite-resistant wood products by separation of termite-attracting flavonoids from the Camptotheca tissues without affecting the CPT tissue content.

### Method and Result

The above experiments show that Camptotheca acuminata wood would be more termite resistant if the termite-attracting flavonoids are extracted from the wood. In July 2000, we conducted an experiment with several pieces of Camptotheca stakes (c. 10 cm in length and 3 cm in diameter) soaked in nanopure water. A month later, water samples were collected from the water with stakes and only water (as control) for HPLC analysis. HPLC profile showed that in the treatment sample, about 90% water-soluble flavonoids were extracted from Camptotheca wood while more than 94% water insoluble CPTs remained in the wood as shown in FIG. 3.

### Example 6

### Objective

To prepare termite-resistant Camptotheca particleboards with desirable physical properties.

### Method and Result

Termite-resistant particleboards were prepared in accordance with the invention, using southern yellow pine mixed with natural Camptotheca acuminata wood after extraction of flavonoids. Six 5-year-old Camptotheca acuminata trees were harvested. The wood materials were classified into: trunk wood without bark, trunk wood with bark, branch wood without bark, and branch wood with bark. The sample materials were chipped and milled into uniformly small particles (20-30 mesh) and soaked in water for a week. The southern yellow pine wood was prepared in the same size as the control sample. All of the wood particles were dried, combined with resin and other binders, and pressed into large panels using heat and pressure. Then the panels were cooled and cut to their finished dimensions. Several types of particleboards, including 100% Camptotheca particleboard, mixed Camptotheca and pine particleboard, and pure Dibol particleboard of pine were processed as listed in Table 3. The particleboard process had no significant effect on the CPT content in the particleboards as shown in FIG. 4. The termite tests in the field demonstrated that all particleboards composed of 30-100% Camptotheca wood materials had no damage after exposure to termites for six months. The particleboards composed of 30-50% Camptotheca wood have similar physical properties (e.g., modulus of rupture: 2,300-3,200 psi; internal bond: 250-310 psi) as the existing southern yellow pine particleboards.

TABLE 3
Some Camptotheca particleboard samples (see Example 6).

| Camptotheca | | | Particleboard | Density |
|---|---|---|---|---|
| Materials | Camptotheca | Pine Wood | Thickness | (pcf*) |
| Trunk Wood and | 100% | 0% | ⅜″ | 47 |
| Bark | | | | |
| Trunk Wood | 100% | 0% | ⅜″ | 50 |
| Trunk Wood | 50% | 50% | ⅜″ | 49 |
| Trunk Wood | 50% | 50% | ¾″ | 47 |
| Stem Wood | 30% | 70% | ⅜″ | 47 |
| — | 0% | 100% | ⅜″ | 47 |

*pounds per cubic foot

What is claimed is:

1. A method for deterring and/or eliminating termites, comprising the steps of:
treating a cellulose product with a solution including at least one natural or synthetic Camptothecin and/or at least one of its natural or synthetic analogs.

2. The method of claim 1, wherein the step of treating said cellulose product with said solution includes spraying the cellulose product with said solution.

3. The method of claim 1, wherein the step of treating said cellulose product with said solution includes soaking the cellulose product with said solution.

4. The method of claim 1, wherein the step of treating said cellulose product with said solution includes pressure-treatment of the cellulose product with said solution.

5. The method of claim 1, wherein the step of treating said cellulose product with said solution includes injection of the cellulose product with said solution.

6. The method of claim 1, wherein said solution is pure CPT.

7. The method of claim 1, wherein said solution is raw CPT.

8. The method of claim 1, wherein said solution is a CPT analog.

9. The method of claim 6, wherein the concentration of said pure CPT is greater than 50 ppm.

10. The method of claim 7, wherein the concentration of said raw CPT is greater than 50 ppm.

11. The method of claim 8, wherein the concentration of said CPT analog is greater than 50 ppm.

12. A method for attracting termites, comprising the step of:
treating a cellulose product with a flavonoid solution.

13. The method of claim 12, wherein the step of treating said cellulose product with said flavonoid solution includes spraying the cellulose product with said flavonoid solution.

14. The method of claim 12, wherein the step of treating said cellulose product with said flavonoid solution includes soaking the cellulose product with said flavonoid solution.

15. The method of claim 12, wherein the step of treating said cellulose product with said flavonoid solution includes pressure treating the cellulose product with said flavonoid solution.

16. A method for attracting and eliminating termites, comprising the steps of:
treating a first cellulose product with a flavonoid solution; and
treating a second cellulose product with a solution including at least one natural or synthetic Camptothecin and/or at least one of its natural or synthetic analogs.

17. The method of claim 16, further including the step of placing said first and second cellulose products in the proximity of a termite colony.

18. The method of claim 16, wherein said solution is pure CPT.

19. The method of claim 16, wherein said solution is raw CPT.

20. The method of claim 16, wherein said solution is a CPT analog.

21. The method of claim 18, wherein the concentration of said pure CPT is 0.1 ppm to 1,200 ppm.

22. The method of claim 19, wherein the concentration of said raw CPT is 0.1 ppm to 1,200 ppm.

23. The method of claim 20, wherein the concentration of said CPT analog is 0.1 ppm to 1,200 ppm.

24. The method of claim 18, wherein the concentration of said pure CPT is 0.1 ppm to 100 ppm.

25. The method of claim 19, wherein the concentration of said raw CPT is 0.1 ppm to 100 ppm.

26. The method of claim 20, wherein the concentration of said CPT analog is 0.1 ppm to 100 ppm.

27. The method of claim 16, wherein the step of treating said first cellulose product with said solution includes spraying said first cellulose product with said solution.

28. The method of claim 16, wherein the step of treating said first cellulose product with said solution includes soaking said first cellulose product with said solution.

29. The method of claim 16, wherein the step of treating said first cellulose product with said solution includes pressure treating said first cellulose product with said solution.

30. A method for using CPTs-containing plant matter to produce termite-resistant cellulose products, comprising the steps of:
removing flavonoids from CPTs-containing plant matter;
drying said CPTs-containing plant matter;
processing said CPTs-containing plant matter;
processing a cellulose product for combination with said CPTs-containing plant matter; and
combining said CPTs-containing plant matter with said cellulose product.

31. The method of claim 30, wherein the step of removing flavonoids from CPTs-containing plant matter includes soaking said plant matter in water.

32. The method of claim 30, wherein the step of removing flavonoids from CPTs-containing plant matter includes soaking said plant matter in water for 7-30 days.

33. The method of claim 30, wherein the step of drying said CPTs-containing plant matter is by air drying.

34. The method of claim 30, wherein the step of drying said CPTs-containing plant matter is by heat drying.

35. The method of claim 30, wherein the step of drying said CPTs-containing plant matter is by freeze drying.

36. The method of claim 30, wherein the step of processing said CPTs-containing plant matter further includes the steps of:
chipping said CPTs-containing plant matter; and/or
milling said CPTs-containing plant matter; wherein said chipping and said milling of said CPTs-containing plant matter yields uniformly small particles.

37. The method of claim 36, wherein said uniformly small particles are 20-30 mesh.

38. The method of claim 30, wherein the step of processing said cellulose product further includes the steps of:
chipping said cellulose product; and/or
milling said cellulose product; wherein said chipping and said milling of said cellulose product yields uniformly small particles.

39. The method of claim 38, wherein said uniformly small particles are 20-30 mesh.

40. The method of claim 38, wherein the step of combining said CPTs-containing plant matter with said cellulose product further includes the steps of:
drying said uniformly small particles of said CPTs-containing plant matter and said uniformly small particles of said cellulose product;
combining said uniformly small particles of said CPTs-containing plant matter and said uniformly small particles of said cellulose product with resin and binders; and
pressing said combination of uniformly small particles of said CPTs-containing plant matter, said uniformly small particles of said cellulose product, said resin, and said binders into panels using heat and pressure.

41. The method of claim 30, wherein said CPTs-containing plant matter is wood.

42. The method of claim 30, wherein said CPTs-containing plant matter is bark.

43. The method of claim 30, wherein said combination of said CPTs-containing plant matter with said cellulose product is 30-100% CPTs-containing plant matter.

44. The method of claim 30, wherein said combination of said CPTs-containing plant matter with said cellulose product is 30-50% CPTs-containing plant matter.

45. A termiticide comprising at least one natural or synthetic Camptothecin and/or at least one of its natural or synthetic analogs.

46. The termiticide of claim 45, wherein said at least one natural or synthetic Camptothecin and/or at least one of its natural or synthetic analogs originates from CPTs-containing plants.

47. The termiticide of claim 45, wherein said at least one natural or synthetic Camptothecin and/or at least one of its natural or synthetic analogs originates from Camptotheca trees.

48. The termiticide of claim 45, wherein said at least one natural or synthetic Camptothecin and/or at least one of its natural or synthetic analogs originates from synthesis.

49. A system for attracting termites comprising flavonoids.

50. The system of claim 49, wherein said flavonoids originate from plants.

51. The system of claim 49, wherein said flavonoids originate from Camptotheca.

52. The system of claim 49, wherein said flavonoids originate from synthesis.

53. A system for attracting and eliminating termites, comprising flavonoids-containing plant matter and CPTs-containing plant matter.

54. A termite-resistant product comprising:
a cellulose product containing CPTs and/or CPTs-containing plant matter.

55. The termite-resistant product of claim 54, wherein said cellulose product is composition board.

56. The termite-resistant product of claim 54, wherein said cellulose product is particleboard.

57. The termite-resistant product of claim 54, wherein said cellulose product is fiberboard.

58. The termite-resistant product of claim 54, wherein said CPTs-containing plant matter is wood.

59. The termite-resistant product of claim 54, wherein said CPTs-containing plant matter is bark.

60. The termite-resistant product of claim 54, wherein the percentage of said CPTs-containing plant matter is 30-100%.

61. The termite-resistant product of claim 54, wherein the percentage of said CPTs-containing plant matter is 30-50%.

62. A termite-resistant structure comprising a termite-resistant cellulose product, wherein said termite-resistant cellulose product contains CPTs and/or CPTs-containing plant matter.

63. The termite-resistant structure of claim 62, wherein said structure is furniture.

64. The termite-resistant structure of claim 62, wherein said structure is shelving.

65. The termite-resistant structure of claim 62, wherein said structure is a cabinet.

66. The termite-resistant structure of claim 62, wherein said structure is a fixture.
